(19) United States
(12) Patent Application Publication
(10) Pub. No.: US 2015/0346793 A1
(43) Pub. Date: Dec. 3, 2015

(54) SELECTIVE ASSEMBLING TYPE COMPUTING DEVICE

(71) Applicants: Inventec (Pudong) Technology Corporation, Shanghai (CN); INVENTEC CORPORATION, Taipei City (TW)

(72) Inventors: Feng-Ku WANG, Taipei City (TW); Lung-Hsun SONG, Taipei City (TW); Chun-Chi LIN, Taipei City (TW); Chia-Cheng SHIH, Taipei City (TW)

(21) Appl. No.: 14/682,616

(22) Filed: Apr. 9, 2015

(30) Foreign Application Priority Data
Jun. 3, 2014 (CN) 201410243368.0

(51) Int. Cl. G06F 1/26; G06F 13/40

(52) U.S. Cl. CPC G06F 1/266; G06F 13/4068

(57) ABSTRACT

A selective assembling type computing device includes a host computer and at least one peripheral device. The host computer has a first host external connection surface and a second host external connection surface, and the peripheral device has a first peripheral device external connected surface and a second peripheral device external connected surface. The peripheral device is provided for selectively assembling to the first host external connection surface or the second host external connection surface through assembling the second peripheral device external connected surface to the first host external connection surface or through assembling the first peripheral device external connected surface to the second host external connection surface. When the peripheral device is assembled to the host computer, the host computer detects the peripheral device to obtain at least one electrical operating parameter of the peripheral device to accordingly transmit a working power to the peripheral device.

### FIELD OF THE INVENTION

The present invention relates to a computing device, and more particularly, to a selective assembling type computing device capable of selectively assembling at least one peripheral device to assembling surfaces of a host computer.

### BACKGROUND OF THE INVENTION

Attending with the development of computer industry, desktop computers are gradually replaced by laptop computers. However, because mobility is less concerned for some specific computers, such as home computers, the market of desktop computer still exists. Even though, because of limited house storage space and distinct operating requirements, home computer nowadays has the developments toward small size, cloud computing, and modular design.

On the premise, the conventional desktop computers would be gradually replaced by minicomputers. The modern minicomputer only keeps the basic operating ability of the personal computer, thus, the size can be significantly reduced. In addition, to fulfill the demand of various usages, the minicomputers also have high expandability such that the users can selectively assembling the other peripheral devices to the host computer according to the need of the user.

FIG. 1 is a schematic view showing the assembly of a conventional computing device. As shown, the computing device includes a host computer PA1 and a peripheral device PA2. The host computer PA1 has two assembling parts PA11 and PA12 assembled to two of the assembling surfaces of the host computers PAL The peripheral device PA2 has an assembling part PA21 assembled to one of the assembling surfaces thereof. The peripheral device PA2 can be assembled to the host computer PA1 merely by the way of assembling the assembling part PA21 to the assembling part PA11 or PA12.

However, because the peripheral device PA2 does not have any assembling part assembled to the other assembling surfaces thereof, it cannot be used to further assemble another peripheral device PA3. In addition, because the host computer PA1 does not have any assembling part assembled to the other assembling surfaces thereof, it cannot be used to further electrically connect the peripheral device PA4 as shown in FIG. 1.

As mentioned above, expandability and variety of conventional host computers and peripheral devices are still quite limited, especially for the peripheral device assembled to the host computer. Accordingly, it is needed to provide a computing device with various assembling selections and capable of modular assembling. Thus, how to provide a peripheral device with strong expandability even when the peripheral device has been assembled to the host computer so as to form various computing devices upon the need of the user is an important topic to be resolved in the present invention.

### BRIEF SUMMARY OF INVENTION

As mentioned above, expandability and assembling selection of the computer host computer and the peripheral device are quite limited, especially for the peripheral device been assembled to the host computer.

A selective assembling type computing device is provided in accordance with the present invention. The computing device includes a host computer and at least one peripheral device. The host computer has a plurality of host external connection surfaces and further comprises at least one first host external connected component, at least one second host external connected component, a processing unit, a detecting circuit, and a power supply.

The first host external connected component and the second host external connected component are respectively assembled to a first host external connection surface and a second host external connection surface of the plurality of host external connection surfaces opposite with each other. The processing unit is electrically connected to the first host external connected component and the second host external connected component. The detecting circuit is electrically connected to the first host external connected component, the second host external connected component, and the processing unit. The power supply is electrically connected to the first host external connected component, the second host external connected component, and the processing unit. The peripheral device has a plurality of peripheral device external connected surfaces operated according to at least one electrical operating parameter. The peripheral device further comprises at least one first peripheral device external connected component and at least one second peripheral device external connected component. The first peripheral device external connected component and the second peripheral device external connected component are respectively assembled to a first peripheral device external connected surface and a second peripheral device external connected surface of the plurality of host external connection surfaces opposite with each other, and the first peripheral device external connected component and the second peripheral device external connected component are electrically connected with each other.

When assembling the above mentioned computing device, the peripheral device is capable of selectively assembling to the first host external connection surface or the second host external connection surface through assembling the second peripheral device external connected component to the first host external connected component or through assembling the first peripheral device external connected component to the second host external connected component. When the peripheral device is assembled to the host computer, the first peripheral device external connected component or the second peripheral device external connected component without being assembled to the host computer is capable of further assembling to another peripheral device.

When the peripheral device is assembled to the host computer, the detecting circuit detects the peripheral device and the processing unit obtains the electrical operating parameter of the peripheral device accordingly to have the power supply transmit a working power to the peripheral device accordingly such that the peripheral device is capable to operate together with the host computer to have the computing device possess the functions of both the host computer and the peripheral device.

In accordance with a preferred embodiment of the present invention, the host computer and the peripheral device may be assembled to each other by the way of mechatronics. That is, mechanical and electrical connections can be completed by the same unit. For example, the first host external connected component is a male type connector, the second host external connected component is a female type connector, the first peripheral device external connected component is a male type connector, and the second peripheral device external connected component is a female type connector. After the male type connector and the female type connector are connected, both mechanical and electrical connections between the host computer and the peripheral device can be achieved.

Besides, the host computer and the peripheral device may be assembled to each other by the way of separated mechanical and electrical connections. That is, two components are used to complete the mechanical connection and the electrical connection respectively. For example, the first host external connected component may include a host external connected structure and a host external electrical coupling unit, the second peripheral device external connected component may include a peripheral device external connected structure and a peripheral device external electrical coupling unit. When the peripheral device external connected structure is assembled to the host external connected structure, the host external electrical coupling unit is electrically coupled to the peripheral device external electrical coupling unit. That is, the mechanical connection is achieved by the peripheral device external connected structure and the host external connected structure, and the electrical connection is achieved by the peripheral device external electrical coupling unit and the peripheral device external electrical coupling unit. As a preferred embodiment, the host external electrical coupling unit may comprise a charging plate for providing working power to the peripheral device through the peripheral device external electrical coupling unit by means of electric coupling.

In addition, the peripheral device may have a recognition code, the host computer may further comprise a memory unit electrically connected to the processing unit. The memory unit stores a plurality of recognition codes corresponding to a plurality of peripheral devices, and each of the recognition codes is corresponding to the at least one electrical operating parameter such that the processing unit is capable of deriving the electrically operating parameter of the peripheral device according to the recognition code.

In addition, the peripheral device may be an external antenna device, a hard disk drive (HDD), a video graphics array (VGA) device, an audio device, or other peripheral devices capable of assembling to the host computer.

With the novel designs in both mechanism and electricity, especially the features that each of the assembling surfaces of the host computer and the peripheral device is provided with an assembling module and all the assembling modules are electrically connected with each other, not only the host computer, the peripheral device assembled to the host computer also possess strong expandability. Thereby, the host computer is capable of connecting a plurality of peripheral devices directly and further connecting more peripheral devices through the assembled peripheral device. With no doubt, various computing devices can be formed by the assembling method provided in the present invention, and the computing devices also possess strong and changeable functions to fulfill the need of users.

The embodiments in the present invention would be further discussed by using the flowing paragraphs and figures for a better understanding.

### BRIEF DESCRIPTION OF THE DRAWINGS

FIG. 1 is a schematic view showing the assembly of a conventional computing device.

FIG. 2 is a schematic view showing the structure of the fundamental components of the computing device in accordance with a preferred embodiment of the present invention.

FIGS. 3A to 3F are schematic views showing the host external connection surface of the host computer, which is utilized to have the peripheral device selectively assembled to the host computer, in accordance with a preferred embodiment of the present invention.

FIG. 4 is a schematic view showing the structure of the peripheral device being assembled to the host computer in accordance with a preferred embodiment of the present invention, which is capable of further assembling another peripheral device through the peripheral device external connected surface without being assembled to the host computer.

FIG. 5A is a block diagram showing an embodiment of the electric circuit of the host computer or the peripheral device in the computing device in accordance with the present invention.

FIG. 5B is a block diagram showing another embodiment of the electric circuit of the host computer or the peripheral device in the computing device in accordance with the present invention.

FIG. 6 is a block diagram showing still another embodiment of the electric circuit of the host computer or the peripheral device in the computing device in accordance with the present invention.

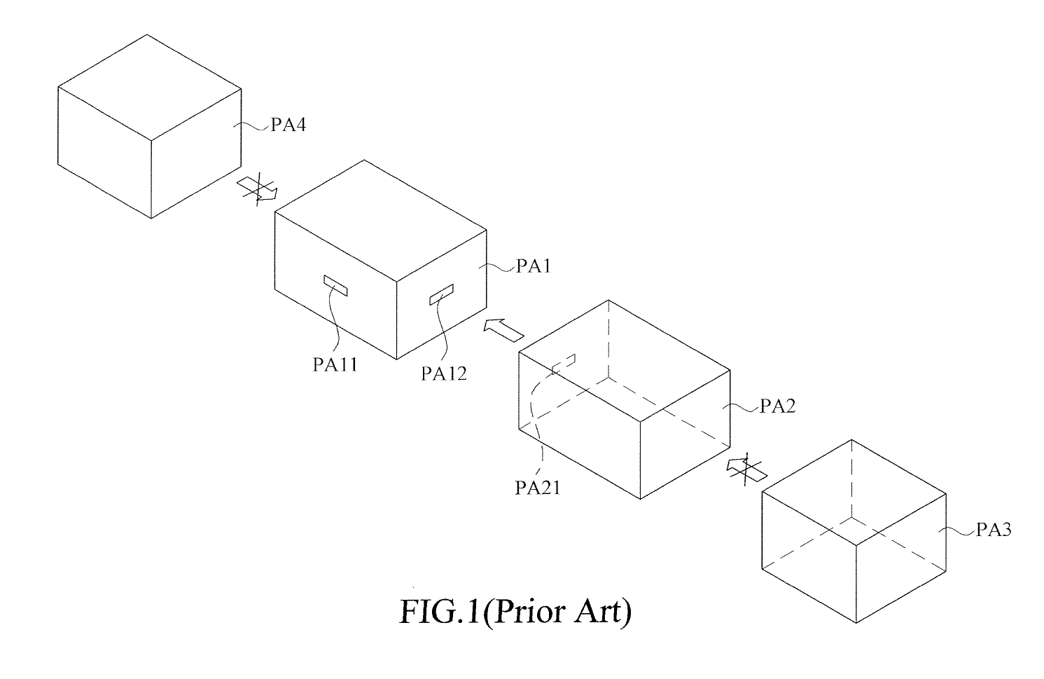

### DETAILED DESCRIPTION OF THE INVENTION

There are various embodiments of the computing device in accordance with the present invention, which are not repeated hereby. Only the preferred embodiments are mentioned in the following paragraphs as an example. It should be understood by those skilled in the art that the preferred embodiments disclosed in the following paragraphs are merely an example instead of restricting the scope of the invention itself.

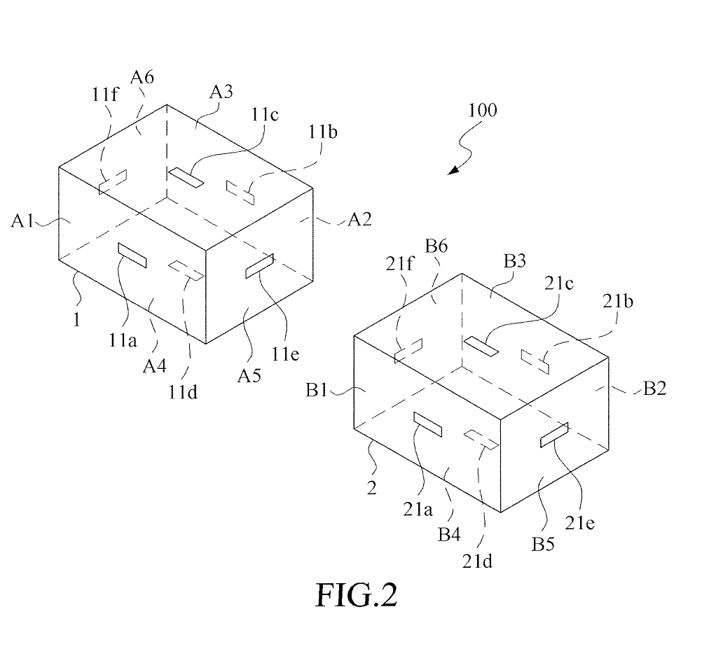

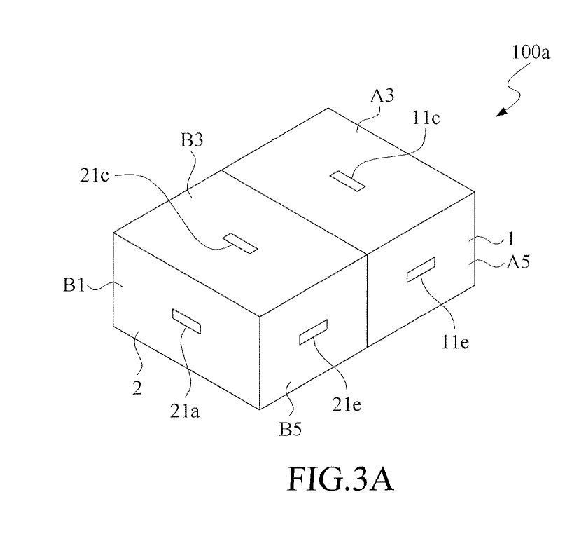

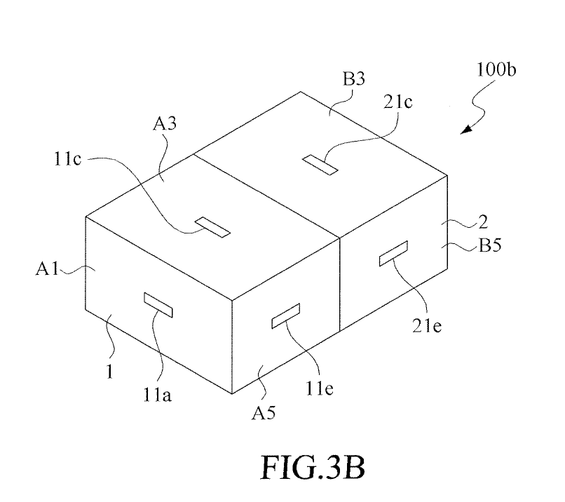

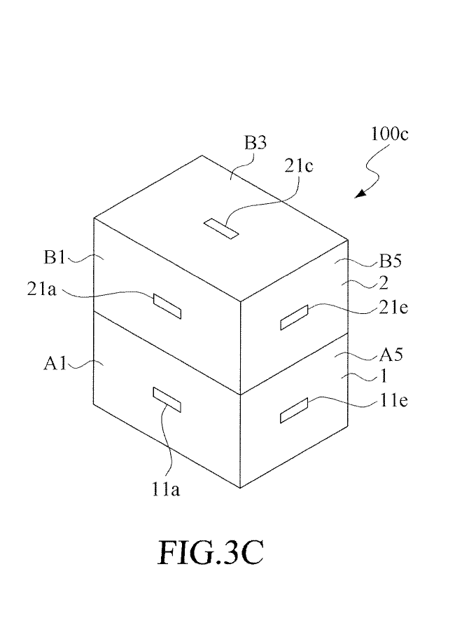

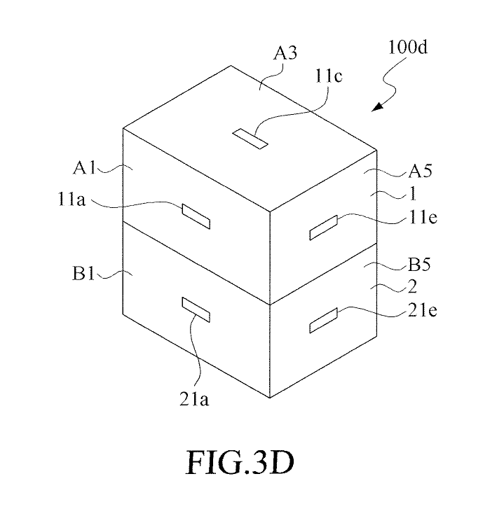

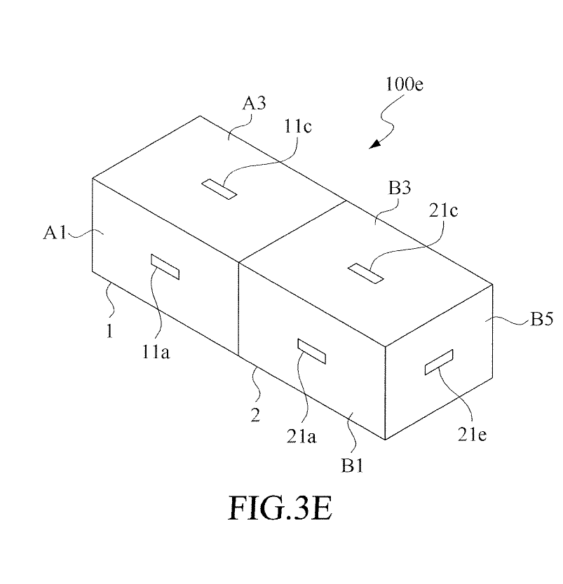

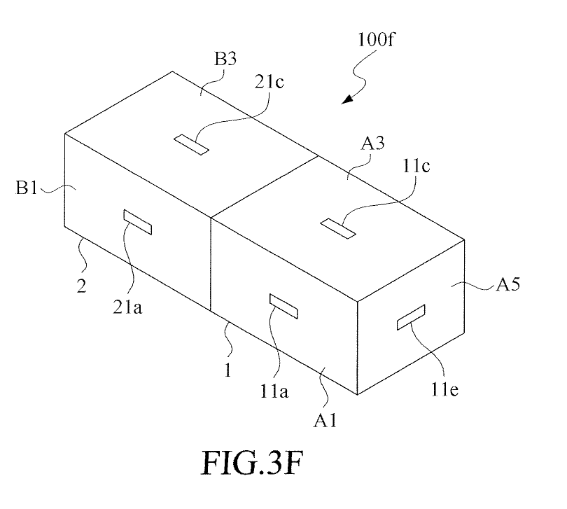

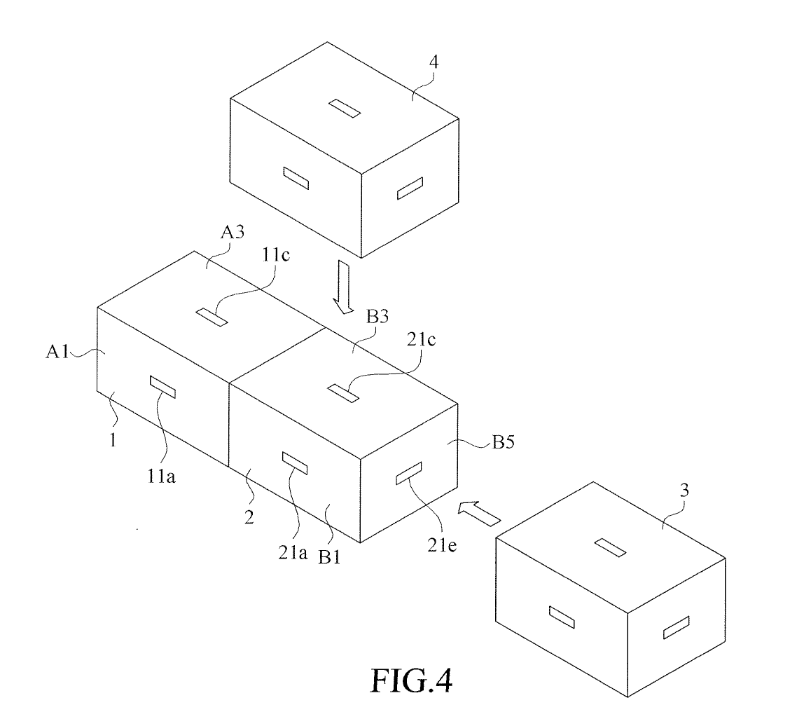

Please refer to FIGS. 2 to 4, of which FIG. 2 is a schematic view showing the structure of the fundamental components of the computing device in accordance with a preferred embodiment of the present invention; FIGS. 3A to 3F are schematic views showing the host external connection surface of the host computer, which is utilized to have the peripheral device selectively assembled to the host computer, in accordance with a preferred embodiment of the present invention; and FIG. 4 is a schematic view showing the structure of the peripheral device being assembled to the host computer in accordance with a preferred embodiment of the present invention, which is capable of further assembling another peripheral device through the peripheral device external connected surface without being assembled to the host computer.

As shown in FIG. 2, in appearance, the computing device 100 includes a host computer 1 and at least one peripheral device 2. The host computer 1 is utilized to execute the basic functions of the computing device 100. The peripheral device 2 may be an external antenna device, a hard disk drive (HDD), a video graphics array (VGA) device, an audio device, or other peripheral devices capable of assembling to the host computer 1.

The host computer 1 has a plurality of host external connection surfaces, including three first host external connection surfaces A1, A3, and A5 and three second host external connection surfaces A2, A4, and A6. Wherein the first host external connection surfaces A1, A3, and A5 are opposite to the second host external connection surfaces A2, A4, and A6 respectively. That is, the first assembling surfaces A1, A3, and A5 and the second assembling surfaces A2, A4, and A6 are located at the opposite sides of the host computer 1. The host computer 1 includes three first host external connected components 11a, 11c, and 11e and three second host external connected components 11b, 11d, and 11f, wherein the first host external connected components 11a, 11c, and 11e are assembled to the first host external connection surfaces A1, A3, and A5 respectively, and the second host external connected components 11b, 11d, and 11f are assembled to the second host external connection surfaces, A2, A4, and A6 respectively.

The peripheral device 2 has a plurality of peripheral device external connected surfaces and is operated according to at least one electrical operating parameter. The electrical operating parameters may be a working current, a working voltage, the duty cycle, the waveform of voltage or current, or other electrical parameters related to the operation of the peripheral device. The plurality of peripheral device external connected surfaces mentioned above may include three first peripheral device external connected surfaces B1, B3, and B5 and three second peripheral device external connected surfaces B2, B4, and B6. The first peripheral device external connected surfaces B1, B3, and B5 are opposite to the second peripheral device external connected surfaces B2, B4, and B6 respectively. That is, the first peripheral device external connected surfaces B1, B3, and B5 and the second peripheral device external connected surfaces B2, B4, and B6 are located at the opposite sides of the peripheral device 2.

The peripheral device 2 includes three first peripheral device external connected components 21a, 21c, and 21e and three second peripheral device external connected components 21b, 21d, and 21f, wherein the first peripheral device external connected components 21a, 21c, and 21e are assembled to the first peripheral device external connected surfaces B1, B3, and B5 respectively, and the second peripheral device external connected components 21b, 21d, and 21f are assembled to the second peripheral device external connected surfaces B2, B4, and B6 respectively. The first peripheral device external connected components 21a, 21c, and 21e and the second peripheral device external connected components 21b, 21d, and 21f are electrically connected with each other.

As shown in FIGS. 3A to 3F, as the peripheral device 2 is assembled to the host computer 1, the peripheral device 2 may be selectively assembled to the first host external connection surfaces A1, A3, or A5 to form the computing device 100a, 100c, or 100e respectively through selectively assembling the second peripheral device external connected components 21b, 21d, or 21f to the first host external connected components 11a, 11c, or 11e respectively. On the other hand, the peripheral device 2 may be selectively assembled to the second host external connection surfaces A2, A4, or A6 to form the computing device 100b, 100d, or 100f respectively through selectively assembling the first peripheral device external connected components 21a, 21c, or 21e to the second host external connected components 11b, 11d, or 11f respectively.

As shown in FIG. 4, as the second peripheral device external connected component 21f (labeled in FIG. 2) is assembled to the first host external connected component 11e (labeled in FIG. 2), the peripheral device 2 is assembled to the first host external connection surface A5 of the host computer 1. At this time, the first peripheral device external connected component 21a, 21c, or 21e, or the second peripheral device external connected component 21b or 21d of the peripheral device 1, which is not assembled to the host computer 1, can be used to assemble another peripheral device. In FIG. 4, only the first peripheral device external connected component 21c or 21e is shown for assembling another peripheral device 3 or 4.

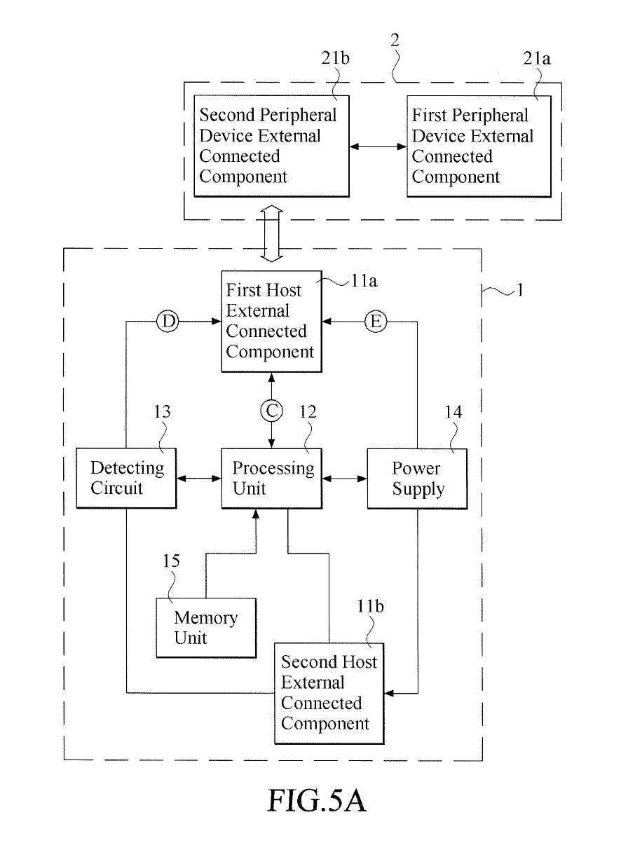

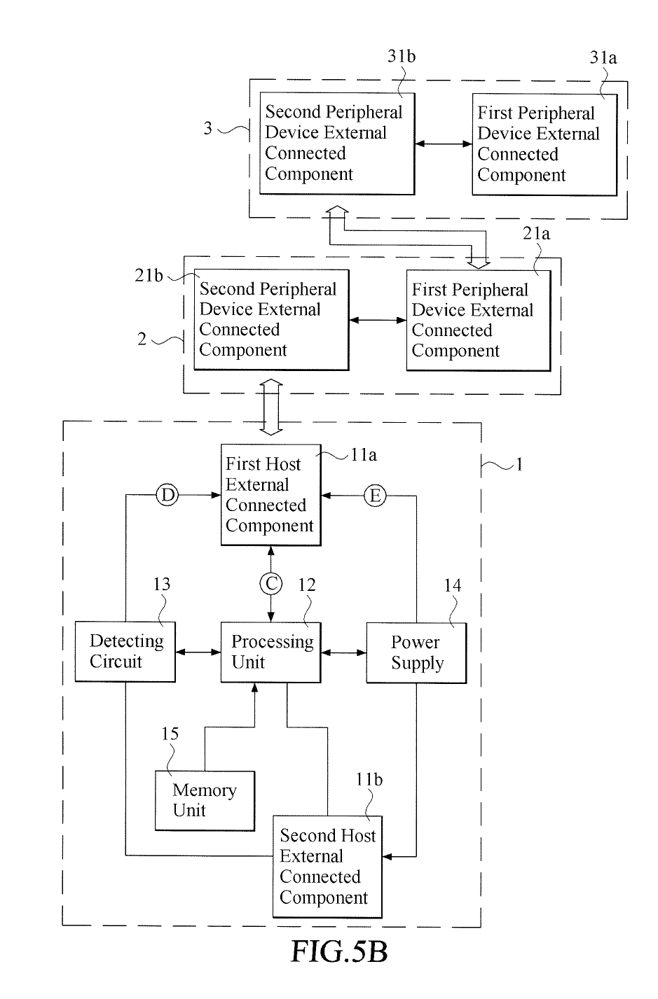

FIG. 5A is a block diagram showing the electric circuit of the host computer or the peripheral device in the computing device in accordance with an embodiment of the present invention. As shown in FIG. 5A, in addition to the above mentioned first host external connected component (only a first host external connected component 11a is labeled) and the second host external connected component (only a second host external connected component 11b is labeled), the host computer 1 also has a processing unit 12, a detecting circuit 13, a power supply 14 and a memory unit 15.

The processing unit 12 is electrically connected to the first host external connected component 11a and the second host external connected component 11b. The detecting circuit 13 is electrically connected to the first host external connected component 11a, the second host external connected component 11b, and the processing unit 12. The power supply 14 is electrically connected to the first host external connected component 11a, the second host external connected component 11b, and the processing unit 12. The memory unit 15 is electrically connected to the processing unit 12.

As the host computer 1 and the peripheral device 2 are assembled to each other by the way of mechatronics, i.e. mechanical and electrical connections are completed by the same connecting unit, the first host external connected component 11a, 11c, or 11e and the second host external connected component 11b, 11d, or 11f may be the connectors matching with each other. For example, the first host external connected component 11a, 11c, or 11e may be a male type connector, the second host external connected component 11b, 11d, or 11f may be a female type connector, the first peripheral device external connected component 21a, 21c, or 21e may be a male type connector, and the second peripheral device external connected component 21b, 21d, or 21f may be a female type connector. After the male type connector and the female type connector are connected with each other, both mechanical and electrical connections between the host computer 1 and the peripheral device 2 can be achieved.

As the peripheral device 2 is assembled to the host computer 1, the peripheral device 2 is detected by the detecting circuit 13 and the processing unit 12 obtains the electrical operating parameter of the peripheral device 2 to have the power supply 14 transmit a working power to the peripheral device 2 accordingly such that the peripheral device 2 is capable to be operated together with the host computer 1 to have the computing device possessing the functions of both the host computer 1 and the peripheral device 2.

As a preferred embodiment, the peripheral device 2 may have a recognition code. The memory unit 15 is capable to store a plurality of recognition codes corresponding to a plurality kinds of peripheral devices (including the peripheral device 2), and each of the recognition codes is corresponding to the at least one electrical operating parameter such that the processing unit 12 is capable to derive the electrically operating parameter of the peripheral device 2 according to the recognition code.

FIG. 5B is a block diagram showing the electric circuit of the host computer or the peripheral device in the computing device in accordance with another embodiment of the present invention. As shown, the computing device may comprise another peripheral device (such as the peripheral device 3 mentioned above). Similar to the peripheral device 2, the peripheral device 3 may have a first peripheral device external connected component 31 a and a second peripheral device external connected component 31b. As the peripheral device 2 is assembled to the host computer 1 and the peripheral device 3 is further assembled to the peripheral device 2, the peripheral device 3 is detected by the detecting circuit 13 and the processing unit 14 obtains at least one extending electrical operating parameter needed for the peripheral device 3 such that the power supply 14 transmits the working power and an extending operating power to the peripheral device 2 and the peripheral device 3 based on the electrical operating parameter and the extending electrical operating parameter of the peripheral device 2 and the peripheral device 3 respectively to have the computing device possessing the functions of the host computer 1 and the peripheral devices 2 and 3.

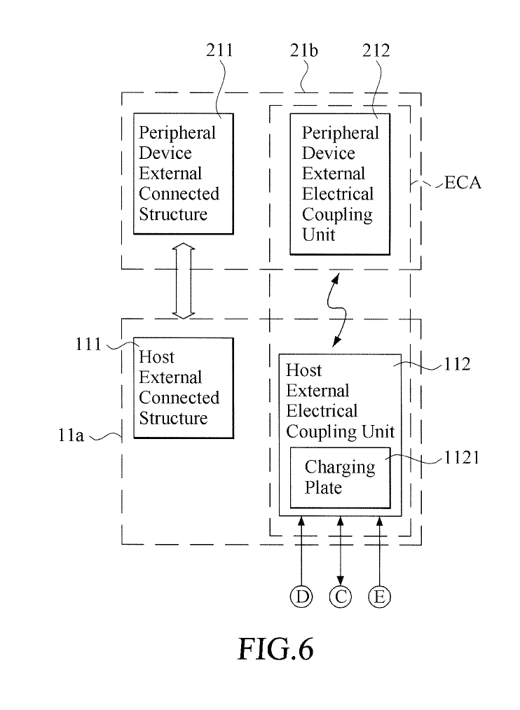

FIG. 6 is a block diagram showing the electric circuit of the host computer or the peripheral device in the computing device in accordance with still another embodiment of the present invention. Other than the connection of mechatronics mentioned above, the host computer 1 and the peripheral device 2 may be assembled to each other by the way of separated mechanical and electrical connections. That is, two components are used to complete the mechanical connection and the electrical connection respectively. As shown in FIG. 6, the first host external connected component 11a may include a host external connected structure 111 and a host external electrical coupling unit 112, the second peripheral device external connected component 21b may include a peripheral device external connected structure 211 and a peripheral device external electrical coupling unit 212. When the peripheral device external connected structure 211 is assembled to the host external connected structure 111, the host external electrical coupling unit 112 is electrically coupled to the peripheral device external electrical coupling unit 212. That is, the mechanical connection is achieved by the peripheral device external connected structure 211 and the host external connected structure 111, and the electrical connection is achieved by the host external electrical coupling unit 112 and the peripheral device external electrical coupling unit 212. The above mentioned peripheral device external connected structure 211 and the host external connected structure 111 may be the engaging members, the plug and socket members, the quick assembling/quick release members connector, the magnetic members or other structures capable of doing mechanical connection.

As a preferred embodiment, the host external electrical coupling unit 112 may comprise a charging plate 1121 for providing working power to the peripheral device 2 through the peripheral device external electrical coupling unit 212 by means of electric coupling. As the peripheral device external connected structure 211 is mechanically connected to the host external connected structure 111, the host external electrical coupling unit 112 and the peripheral device external electrical coupling unit 222 must be positioned within an effective coupling area (ECA) to generate such electric coupling effectively.

With the novel designs in both mechanism and electricity, especially the features that each of the assembling surfaces of the host computer and the peripheral device is provided with an assembling module and all the assembling modules are electrically connected with each other, not only the host computer, the peripheral device assembled to the host computer also possess strong expandability. Thereby, the host computer is capable of connecting a plurality of peripheral devices directly and further connecting more peripheral devices through the assembled peripheral device. With no doubt, various computing devices can be formed by the assembling method provided in the present invention, and the computing devices also possess strong and changeable functions to fulfill the need of users.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A selective assembling type computing device comprising:
a host computer, having a plurality of host external connection surfaces, and comprising:
at least one first host external connected component and at least one second host external connected component, respectively assembled to a first host external connection surface and a second host external connection surface opposite with each other of the plurality of host external connection surfaces;
a processing unit, electrically connected to the first host external connected component and the second host external connected component;
a detecting circuit, electrically connected to the first host external connected component, the second host external connected component, and the processing unit;
a power supply, electrically connected to the first host external connected component, the second host external connected component, and the processing unit;
at least one peripheral device, having a plurality of peripheral device external connected surfaces, being operated according to at least one electrical operating parameter, and the peripheral device comprising:
at least one first peripheral device external connected component and at least one second peripheral device external connected component, respectively assembled to a first peripheral device external connected surface and a second peripheral device external connected surface of the plurality of host external connection surfaces opposite with each other, and the first peripheral device external connected component and the second peripheral device external connected component being electrically connected with each other;
wherein the peripheral device is utilized for selectively assembling to the first host external connection surface or the second host external connection surface of the host computer through assembling the second peripheral device external connected component to the first host external connection component or through assembling the first peripheral device external connected component to the second host external connection component; the first peripheral device external connected component or the second peripheral device external connected component of the peripheral device which is not assembled to the host computer is utilized for assembling to another peripheral device; and when the peripheral device is assembled to the host computer, the host computer detects the peripheral device to analyze and obtain the electrical operating parameter of the peripheral device to have the power supply transmit a working power to the peripheral device accordingly.

2. The selective assembling type computing device of claim 1, wherein the first host external connected component is a male type connector and the second peripheral device external connected component is a female type connector.

3. The selective assembling type computing device of claim 1, wherein the second host external connected component is a female type connector and the first peripheral device external connected component is a male type connector.

4. The selective assembling type computing device of claim 1, wherein the first host external connected component comprises a host external connected structure and a host external electrical coupling unit, the second peripheral device external connected component comprises a peripheral device external connected structure and a peripheral device external electrical coupling unit; when the peripheral device external connected structure is assembled to the host external connected structure, the host external electrical coupling unit is electrically coupled to the peripheral device external electrical coupling unit.

5. The selective assembling type computing device of claim 4, wherein the host external electrical coupling unit comprises a charging plate.

6. The selective assembling type computing device of claim 1, wherein the peripheral device has a recognition code, the host computer further comprises a memory unit electrically connected to the processing unit to store a plurality of recognition codes corresponding to a plurality kinds of peripheral devices, and each of the recognition codes is corresponding to the at least one electrical operating parameter such that the processing unit derives the electrically operating parameter of the peripheral device according to the recognition code.

7. The selective assembling type computing device of claim 1, wherein the peripheral device is an external antenna device, a hard disk drive (HDD), a video graphics array (VGA) device, or an audio device.
